(19) United States
(12) Patent Application Publication
(10) Pub. No.: US 2006/0173902 A1
(43) Pub. Date: Aug. 3, 2006

(54) Integrated development method for RAM-LSA-TM

(75) Inventors: Sang-Kyun Mok, Seo-Gu (KR); Jong-Wook Bae, Joong-Gu (KR); Jong-Min Ahn, Seo-Gu (KR); Jong-Jin Kim, Seo-Gu (KR)

Correspondence Address: GRAYBEAL, JACKSON, HALEY LLP, 155 - 108TH AVENUE NE, SUITE 350, BELLEVUE, WA, 98004-5901, US

(73) Assignee: Agency for Defense Development

(21) Appl. No.: 11/206,328

(22) Filed: Aug. 17, 2005

(30) Foreign Application Priority Data
Jan. 3, 2005 (KR) 00258/2005

(51) Int. Cl. G06F 17/00; G06F 7/00

(52) U.S. Cl. 707/102

(57) ABSTRACT

Disclosed is an integrated development method for RAM-LSA-TM. The integrated development method for RAM-LSA-TM comprises the steps of: comparing the reference number of identification key information of a first item from a Ram part list table of a RAM calculation module DB and the reference number of a second item from a HG table of an international standard DB; if the reference numbers are the same as a result of the comparison, comparing the reference number of the next higher assembly of the identification key information of the first item and the reference number of the next higher assembly of the second item from the HG table of the international standard DB, and determining if the first item and the second item are the same or not based on a result of the comparison; creating a technical manual database by detecting technical manual related information about supply and maintenance from the international standard LSA DB; entering key information specifying a technical manual to register the technical manual based on the entered key information and automatically creating a basic table of contents of the technical manual; and automatically creating a technical manual DB of MIL-PRF-87269 standard by importing data of the LSA DB to the created table of contents.

### BACKGROUND OF THE INVENTION

1. Field of the Invention

The present invention relates to a RAM calculation, LSA and TM development, and more particularly, to an integrated development for RAM-LSA-TM by which RAM-LSA-TM development that has been carried out in independent environments can be performed in an integrated computer environment.

2. Description of the Background Art

Recently, as the structure of military equipment becomes more and more complicated and precise by the fast developing technology, potential safety hazards and the probability of failure are increasing.

To cope with this, more stress is being put on the significance of prediction of RAM (Reliability Availability Maintainability) for more quickly tracking failure causes of military equipment and taking action on them and previously deriving risk factors threatening the safety of equipment and labor and eliminating them than at any time ever. Moreover, research and development for Logistics Support Analysis (LSA) and Technical Manual (TM) for the production of a variety of maintenance manuals are being actively pursued.

However, the aforementioned RAM calculation, LSA and TM development are different from one another in their characteristics although they are organically linked to one another from the viewpoint of tasks, thus there has been difficulty in integrated managing the RAM calculation, LSA and TM development. Therefore, for the RAM calculation, LSA and TM development, the same data has to be entered repeatedly for each task, and if there is any change in data, data of the task related to the changed data also has to be changed, which requires a lot of labor and time in the RAM calculation, LSA and TM development and makes it difficult to maintain consistency between data.

Accordingly, in a conventional system for RAM calculation, LSA and TM development, a file to be entered in a LSA database is created and output from a RAM program, and contents to be included in a technical manual (TM) are created in a word file or HTML or XML file format and output from a LSA DB program.

In such a conventional system for RAM calculation, LSA and TM development, a RAM calculation program and a LSA DB program exist separately, and the compatibility problem between the RAM program and the LSA DB program is solved by creating an export file of the RAM program. Thus, when data is modified or updated, it is difficult to continuously apply the modified or updated data to the RAM program and the LSA DB program.

Further, the LSA and the TM development have to be performed respectively through individual systems due to the format and enormous information amount of paper technical manuals, the heterogeneity between an Interactive Electronic Technical Manual (IETM) standard DB and a LSA DB or the diversity of technical manual construction systems and so on.

### SUMMARY OF THE INVENTION

Therefore, an object of the present invention is to provide an integrated development method for RAM-LSA-TM which can overcome redundant entry of data occurring when a RAM calculation module, a LSA module and a TM module exist independently, the difficulty of editing, the difficulty of maintaining data consistency and applying modifications to a RAM DataBase, a Logistics Support Analysis DataBase and a Technical Manual DataBase in batch, and so on by linking the RAM DataBase and the LSA DataBase and linking the linked LSA DB to the TM DB.

To achieve the above object, there is provided an integrated development method for RAM-LSA-TM according to the present invention, comprising the steps of: comparing the reference number of identification key information of a first item from a Ram part list table of a RAM calculation module DB with the reference number of a second item from a HG table of an international LSA standard DB; if the reference numbers are the same as a result of the comparison, comparing the reference number of the next higher assembly of the identification key information of the first item and the reference number of the next higher assembly of the second item from the HG table of the international LSA standard DB, and determining if the first item and the second item are the same or not based on a result of the comparison; creating a technical manual database by detecting technical manual related information about supply and maintenance from the international standard LSA DB; entering key information specifying a technical manual to register the technical manual based on the entered key information and automatically creating a basic table of contents of the technical manual; and automatically creating a technical manual DB of MIL-PRF-87269 standard by importing data of the LSA DB to the created table of contents.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual view of a RAM-LSA-TM integrated development model according to the present invention;

FIG. 2 is a flow chat showing a process of identifying if an item is the same or not for linking the DB of a RAM calculation module and the DB of a LSA module according to the present invention;

FIG. 3 is a flow chart showing a process for linking the DB of the LSA module and the DB of the TM development module according to the present invention;

### DETAILED DESCRIPTION OF THE PREFERRED EMBODIMENTS

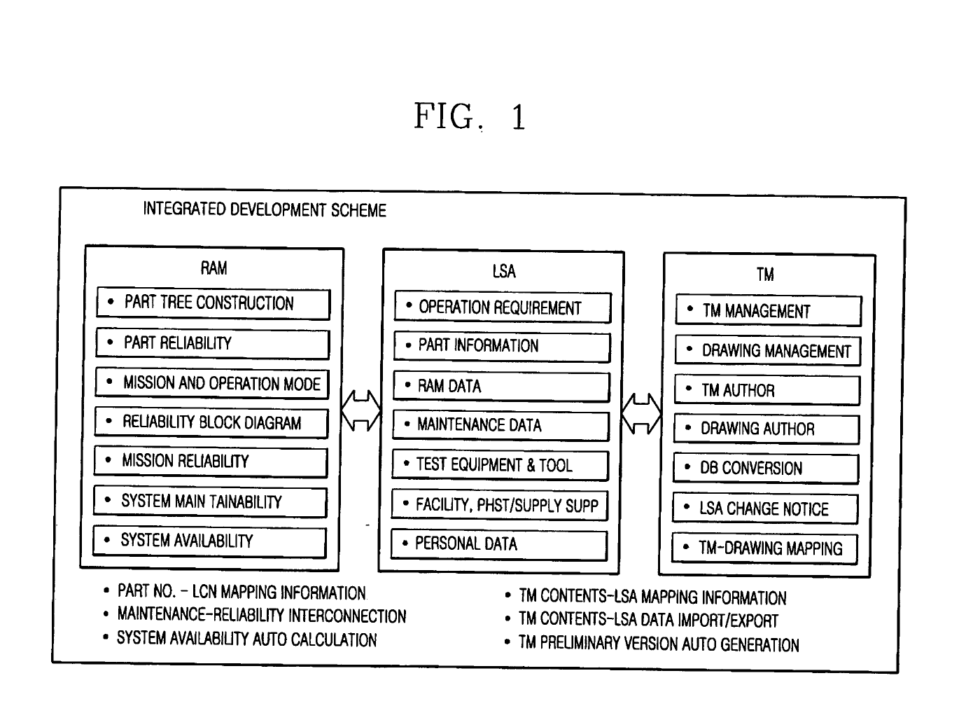

The integrated development method for RAM-LSA-TM according to the present invention will be described in detail with reference to FIGS. 1 to 3.

Firstly, FIG. 1 shows a RAM-LSA-TM integrated development model according to the present invention. The RAM-LSA-TM integrated development model of FIG. 1 is to perform RAM calculation, Logistics Support Analysis and TM development on a database level in an integrated fashion by analyzing the service procedure of RAM calculation, Logistics Support Analysis and TM development tasks and their related standards based on MIL-STD(Military Standards)-1388-2B, which is a logistics support analysis data processing standard.

To implement the integrated development method for RAM-LSA-TM, in explaining a linking method of key information for linking the RAM DB, LSA DB and TM DB, the method of linking the RAM DB, LSA DB and TM DB is divided into a method of linking the RAM DB and the LSA DB and a method of linking the LSA s DB and the TM DB.

Firstly, the method of linking the RAM DB and the LSA DB will be described below.

Generally, a reference number such as a part number is used as information for uniquely identifying a single item. However, in a RAM calculation task, since RAM property value may be different according to the mounting position of an item and the marginal environment thereof even if they are the same item, an item cannot be identified only by its reference number but a reference number of the Next Higher Assembly (NHA) of the item is additionally required. Thus, an identification key of an item of the RAM calculation module can be defined as a combination of ‘weapon system-reference number of item (R/N_ram)-reference number of Next Higher Assembly (R/N_ram of NHA)’ information.

In a LSA task, an identification key of an item is defined as a combination of ‘weapon system (EIAC: End Item Acronym Code)-Usable On Code (UOC)-LSA Control Number (LCN)-LCN Type—Alternate LCN Code (ALC).

Hence, a processing method of identifying if an item of the RAM calculation module and an item of the LSA module are the same item or not through key information (reference numbers of item and next higher assembly) of the item of the RAM calculation module and key information (LCN) of the item of the LSA module is required in order to automatically copy/calculate RAM data of the LSA DB using data of the RAM DB without a user entry task and, reversely, automatically calculate the maintainability and availability of the RAM DB using maintenance task data of the LSA DB, by linking the DB of the RAM calculation module and the DB of the LSA module and managing information in a single integrated database.

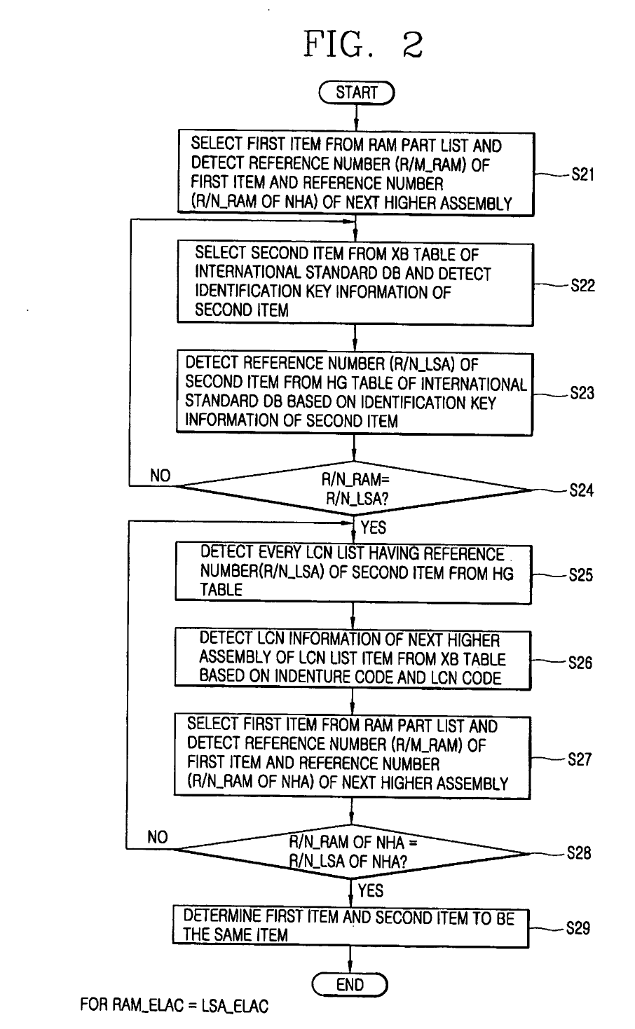

FIG. 2 is a flow chart showing a process of identifying if an item is the same or not for linking the DB of a RAM calculation module and the DB of a LSA module according to the present invention, which will be described below.

Firstly, an item is selected from a RAM parts list table of the DB of the RAM calculation module, and the EIAC and reference number of identification key information of the selected item and the reference number of a next higher assembly of the selected item are detected (S21). Here, the item selected from the RAM part list table is referred to as a first item.

Then, an item is selected from a XB table of a LSA international standard DB, and identification key information (EIAC, LCN) of the selected item is detected (S22). The item selected from the XB table is referred to as a second item.

Continuously, the reference number (R/N_Isa) of the second item is detected from a HG table of the international standard DB based on EIAC-LCN information of the identification key of the second item (S23). The HG table is a table showing the relation between the LCN of an item and the reference number (R/N_Isa) of the item.

The detected reference number (R/N_Isa) of the second item and the detected reference number (R/N_ram) of the identification key information of the first item are compared (S24).

As a result of the comparison, if the detected reference number (R/N_Isa) of the second item and the detected reference number (R/N_ram) of the first item are the same, a LCN list having the reference number (R/N_Isa) of the second item is detected from the HG table (S25). Here, the LCN list is a list showing LCNs and items corresponding to the LCNs. On the contrary, if the detected reference number (R/N_Isa) of the second item and the detected reference number (R/N_ram) of the first item are not the same, the first item and the second item are determined not to be the same. LCN information of the Next Higher Assembly of the second item is detected from the XB table of the international standard DB by LCNs of the detected LCN list by using an Indenture Code and a LCN code (S26).

Afterwards, the reference number (R/N_Isa of NHA) of the Next Higher Assembly is detected from the HG table of the international standard DB based on the detected LCN information of the Next Higher Assembly of the second item (S27).

The reference number (R/N_Isa of NHA) of the Next Higher Assembly of the second item and the reference number (R/N_ram of NHA) of the Next Higher Assembly of the identification key information of the first item are compared (S28).

As a result of the comparison, if the reference number (R/N_Isa of NHA) of the Next Higher Assembly of the second item and the reference number (R/N_ram of NHA) of the Next Higher Assembly of the first item are the same, that is to say, the reference number of the Next Higher Assembly of the first item is consistent with the reference number of the Next Higher Assembly of the second item, the first item and the second item are determined to be the same item (S29). On the other hand, if the reference number (R/N_Isa of NHA) of the Next Higher Assembly and the reference number (R/N_ram of NHA) of the first item are not the same, the first item and the second item are determined not to be the same.

Resultantly, data of the DB of the RAM calculation module and data of the DB of the LSA module can be linked by the processing method of identifying if an item of the RAM calculation module and an item of the LSA module are the same or not. Therefore, by managing the RAM calculation module and the LSA module in a single DB without changing a key structure of the item of the RAM calculation module or the item of the LSA module, a RAM property value, failure mode ratio, maintenance task frequency, etc. can be automatically calculated by items of the LSA module without a user's operation, the calculation of the system maintainability and operation availability of the RAM module can be automatically carried out by using maintenance task information of the LSA module. Consequently, data entry time for the RAM calculation and the LSA is reduced, and data consistency between the RAM calculation and the LSA is assured.

The method of linking the LSA module and the TM development module will be described below.

Technical manuals of various types including a supply manual, maintenance manual, user manual, etc. are developed for the maintenance and repair of equipment. However, because tables of contents of technical manuals, as well as types of technical manuals, are diverse, there is a difficulty in defining the DB structure of a technical manual.

Therefore, in order to link the LSA module database and the technical manual module database, there is required a processing method of defining (entering) key information specifying a technical manual, extracting information to be entered in the specified technical manual from the LSA module DB based on the defined key information, and entering the extracted information in the specified technical manual.

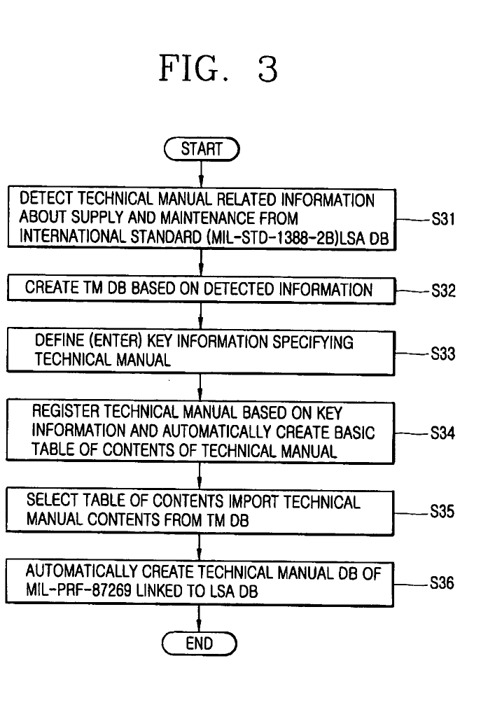

FIG. 3 is a flow chart showing a process for linking the DB of the LSA module and the DB of the TM development module according to the present invention.

Firstly, technical manual-related information, including supply, maintenance, etc., is detected from the international standard (MIL-STD-1388-2B) LSA DB (S31). Based on the detected information, a DB for technical manual (TM) data is created (S32). This is to prevent the dropping of data processing speed of a computer processing system required to extract contents to be included in a technical manual from the LSA DB.

Afterwards, key information specifying a technical manual (TM) is defined (entered) (S33). The key information is for linking the DB of the LSA module and the DB of the TM development module, which is comprised of ‘End Item Acronym Code (EIAC)-TM Category-Maintenance Level-LCN-Alternate LCN Code-Usable On Code (UOC)’. Here, the ‘LCN-Alternate Code-Usable On Code’ is the information for defining a technical manual-related system.

A technical manual is registered based on the defined (entered) key information, and a basic table of contents (chapter, section, paragraph) up to Level 3 of the technical manual is created depending on the TM category. This is focused on the fact that there is not much difference between tables of contents of chapters, sections and paragraphs corresponding to the TM category regardless of weapon system or equipment, and thus a table of contents up to Level 3 is illustrated in a technical manual writing guide or specification. That is, this is the concept of defining a basic table of contents up to Level 3 in advance by TM category, and automatically calling up the basic table of contents of the corresponding technical manual when registering the technical manual.

A user selects a table of contents to import the contents of the technical manual from the DB for TM data (S35).

As designated above, a technical manual DB of MIL-PRF-87269 standard linked to the LSA DB is automatically created by importing the contents of the technical manual from the DB for TM data to the selected table of contents (S36). In the procedure of creating the technical manual DB of MIL-PRF-87269 standard, link information is automatically created such that the technical manual DB and the LSA DB are linked. Thus, when data of the LSA DB is modified or changed, the user may be notified of modifications upon inquiring related data of the technical manual to which changes are applied. Based on this, the consistency between the LSA DB and the TM DB can be maintained.

Resultantly, in the above-stated method of linking the DB of the LSA module and the DB of the TM module, the LSA module and the technical manual module can share mutually needed information bidirectionally through the development of the data selection technique for automatically detecting technical manual information (supply or maintenance) from the LSA DB and the technique for automatically storing extracted information in the MIL-PRF-87269 DB.

As described in detail above, the integrated development for RAM-LSA-TM according to the present invention can overcome redundant entry of data occurring when a RAM calculation module, a LSA module and a TM module exist independently, the difficulty of editing, the difficulty of maintaining data consistency and applying modifications to a RAM DataBase, a Logistics Support Analysis DataBase and a Technical Manual DataBase in batch, and so on by linking the RAM DataBase and the LSA DataBase and linking the linked LSA DB to the TM DB.

It should be noted that the embodiment described above is simply intended to clarify the technical idea of the present invention. Naturally, the technical scope of the present invention should not be construed solely on the basis of the specific embodiment described above. In other words, the present invention can be worked in variously modified fashions on the basis of the spirit of the present invention and within the scope defined in the accompanying claims.

What is claimed is:

1. An integrated development method for RAM-LSA-TM, comprising the steps of
comparing the reference number of identification key information of a first item from a Ram part list table of a RAM calculation module DB and the reference number of a second item from a HG table of an international standard DB;
if the reference numbers are the same as a result of the comparison, comparing the reference number of the next higher assembly of the identification key information of the first item and the reference number of the next higher assembly of the second item from the HG table of the international standard DB, and determining if the first item and the second item are the same or not based on a result of the comparison;
creating a technical manual database by detecting technical manual related information about supply and maintenance from the international standard LSA DB;
entering key information specifying a technical manual to register the technical manual based on the entered key information and automatically creating a basic table of contents of the technical manual; and
automatically creating a technical manual DB of MIL-PRF-87269 standard by importing data of the LSA DB to the created table of contents.

2. The method of claim 1, wherein the reference number of the second item is acquired from the HG table based on the LCN of the identification key of the second item.

3. The method of claim 1, wherein the determination step further comprises the step of detecting LCN information of the next higher assembly of the second item by LCNs of the LCN list created based on the LCN of the identification key of the second item by using an Indenture Code and a LCN code from the XB table of the international standard DB.

4. The method of claim 3, wherein the reference number of the next higher assembly of the second item is acquired from the HG table based on the LCN of the identification key of the next higher assembly of the second item.

5. The method of claim 1, wherein in the determination step, the first item and the second item are determined to be the same when the reference number of the first item and the reference number of the next higher assembly of the first item are consistent with the reference number of the second item and the reference number of the next higher assembly of the second item, respectively.

6. The method of claim 1, wherein the key information specifying the technical manual is comprised of a combination of ‘End Item Acronym Code-TM Category-Maintenance Level-LCN-Alternate LCN Code-Usable on Code.

7. The method of claim 1, further comprising the step of creating link information for linking data of the LSA DB and data of the technical manual DB of MIL-PRF-87269 standard for data consistency.
